(19) United States
(12) Patent Application Publication
(10) Pub. No.: US 2010/0295872 A1
(43) Pub. Date: Nov. 25, 2010

(54) DISPLAY DRIVER AND DRIVING METHOD

(75) Inventors: Yusuke UCHIDA, Tokyo (JP); Yukari KATAYAMA, Chigasaki (JP); Akihito AKAI, Kawasaki (JP); Yoshiki KUROKAWA, Tokyo (JP)

Correspondence Address: MILES & STOCKBRIDGE PC, 1751 PINNACLE DRIVE, SUITE 500, MCLEAN, VA, 22102-3833, US

(73) Assignee: RENESAS ELECTRONICS CORPORATION

(21) Appl. No.: 12/780,915

(22) Filed: May 16, 2010

(30) Foreign Application Priority Data
May 19, 2009 (JP) 2009-120577

(51) Int. Cl. G09G 5/00; G09G 3/36; G06T 9/00

(52) U.S. Cl. 345/660; 345/204; 345/87; 345/555

(57) ABSTRACT

The present invention is directed to improve efficiency in use of a memory for storing display data which is used for an overdrive process. A display driver for driving a display device compresses image display data, stores the compressed data into a memory, and generates a preceding frame by decompressing the data read from the memory. A setting unit divides a display screen of the display device into, for example, a first region as a center part and a second region as a peripheral part. An overdrive computing unit generates overdrive display data in response to a present-time frame and the preceding frame, compresses the image display data in the first and second regions at first and second data compression ratios of small and large values, respectively, and stores the compressed data into the memory. By saving the space of the memory, the picture quality in the first region is improved.

### CLAIM OF PRIORITY

The present application claims priority from Japanese patent application JP 2009-120577 filed on May 19, 2009, the content of which is hereby incorporated by reference into this application.

### FIELD OF THE INVENTION

The present invention relates to a display driver and a driving method and, more particularly, to a technique effective to improve efficiency in use of a memory which is used for overdrive process in order to shorten response time of a display device.

### BACKGROUND OF THE INVENTION

In a small liquid crystal display mounted on a cellular phone terminal or the like, there is a tendency that high-speed liquid crystal used in a stationary television or the like cannot be used due to limitations in cost, size, and the like. On the other hand, in recent years, also in a cellular phone terminal, a need for viewing a motion picture of a one-segment broadcast or the like is growing.

When a motion picture is displayed by a low-speed liquid crystal, there is a case such that it takes longer time than the frame interval to change the gray level of a pixel to a target value, and deterioration in picture quality called “motion picture blur” is visually recognized when the gray level cannot reach the target gray level even at time when data of the next frame has to be displayed. One of liquid crystal driving methods for reducing the motion picture blur is an overdrive process. In the process, by driving the liquid crystal according to a voltage change exceeding a gray level change of a pixel between frames, time required for a gray level change is shortened.

However, an entire liquid crystal screen does not always need the overdrive process. For example, even in a motion picture, there are a video image that background is fixed and only a part of subjects moves and a moving picture which is displayed by using a part of a liquid crystal screen. In such a case, the overdrive process to a part where there is no motion on the screen is unnecessary. Rather, it may deteriorate the picture quality.

For example, as described in the following patent document 1, whether a change amount between frames of a luminance component and a chrominance component of two corresponding pixels is larger than a threshold value or not is determined. A pixel having a change amount larger than the threshold value is determined as a dynamic pixel, and an overdrive process is executed on the dynamic pixel. At the time of determining a dynamic pixel, compressed pixel data of a preceding frame which is supplied from an output of a frame memory to an image decompressing unit and compressed pixel data of a present-time frame to be supplied from an image compressing unit to an input of a frame memory is supplied to a dynamic image detecting unit.

For example, it is described in the following non-patent document 1 that, to reduce a frame memory at the time of the overdrive process, a compression module in which an encoder is coupled to an input of the frame memory and a decoder is coupled to an output of the frame memory is provided on the inside of a liquid crystal display controller. A present-time frame is directly supplied to one of input terminals of the overdrive unit provided in the liquid crystal display controller and is also supplied as a past frame to the other input terminal of the overdrive unit via an encoder, a frame memory, and a decoder of the compression module. It is also described in the patent document 1 that the overdrive unit generates an overshoot and an undershoot depending on the difference between pixel values of continuous frames, so that response time of the liquid crystal is shortened and “motion blur” can be also reduced.

Patent document 1: Japanese patent laid-open No. 2005-316369 Non-patent document 1: John-Woo Han et al, “Vector Quantizer based Block Truncation Coding for Color Image Compression in LCD Overdrive”, IEEE Transactions on Consumer Electronics, Vol. 54, No. 4, November 2008, pp. 1839 to 1845

### SUMMARY OF THE INVENTION

In the overdrive processing method, by comparing the gray level of a pixel in a present-time frame to be displayed and that of the same pixel in the immediately preceding frame, drive voltage is determined. Therefore, in the conventional overdrive processing method, all of pixels in a preceding frame have to be stored in a frame memory. Consequently, pixels which do not need or slightly need the overdrive process such as pixels in a stationary picture region or in a region to which no one pays attention on a screen are also stored in a frame memory like pixels in a region of a large motion. As a result, there is a problem such that use of a frame memory is inefficient in spite of the effect of the overdrive process which is visually recognized by a viewer.

That is, in the case of mounting a frame memory of the same memory capacity, if the use of the memory is inefficient, the compression ratio at the time of storing the pixels is increased, and the data amount per pixel has to be reduced. As a result, the overdrive process is executed on the basis of preceding frame information of low precision, and a problem such that the picture quality deteriorates was made clear by examination of the inventors of the present invention.

The present invention has been achieved on the basis of the examination of the inventors of the present invention performed prior to the present invention, and an object of the invention is to improve use efficiency of a memory for storing display data of a preceding frame pixel used for the overdrive process.

The above and other objects and novel features of the present invention will become apparent from the description of the specification and appended drawings.

Outline of typical ones of inventions disclosed in the application will be briefly described as follows.

A representative embodiment of the present invention relates to a display driver for driving a display device (230).

The display driver (220) compresses image display data, stores the compressed data in a memory (224), and generates a preceding frame by decompressing the data read from the memory (224).

The display driver (220) includes a setting unit (222) and an overdrive computing unit (223).

The setting unit (222) can divide a display screen (102) of the display device (230) into at least a first region (105) and a second region (106).

The overdrive computing unit (223) generates overdrive display data in response to a present-time frame and the preceding frame.

The overdrive computing unit (223) compresses image display data in the first region (105) and image display data in the second region (106) at a first data compression ratio (R_{A}) and a second compression ratio (R_{B}) which are different from each other, respectively, and stores the compressed data into the memory (224) (refer to FIG. 3).

An effect obtained by a representative one of the inventions disclosed in the application will be briefly described as follows.

That is, use efficiency of a memory for storing display data of pixels in a preceding frame used for the overdrive process can be improved.

### BRIEF DESCRIPTION OF THE DRAWINGS

FIGS. 1A and 1B are diagrams for explaining region division of a screen in a liquid crystal display device according to a first embodiment of the invention mounted on a cellular phone terminal.

FIG. 2 is a block diagram showing the display driver of the first embodiment of the invention and peripheral devices.

FIG. 3 is a diagram showing the configuration of an overdrive computing unit 223 of a display driver 220 of the first embodiment of the invention illustrated in FIG. 2.

FIG. 4 is a diagram showing the configuration of a region determining unit 2231 of the overdrive computing unit 223 illustrated in FIG. 3.

FIG. 5 is a diagram showing another configuration of the region determining unit 2231 of the overdrive computing unit 223 illustrated in FIG. 3.

FIG. 6 is a diagram showing the configuration of a compression ratio calculating unit 2232 of the overdrive computing unit 223 illustrated in FIG. 3.

FIG. 7 is a diagram showing the configuration of a compression ratio table 701 included in a compression ratio determining unit 22321 of the compression ratio calculating unit 2232 illustrated in FIG. 6.

FIG. 8 is a diagram for explaining region division of a screen in a liquid crystal display device according to a second embodiment mounted on a cellular phone terminal.

FIG. 9 is a diagram showing the configuration of the overdrive computing unit 223 of the display driver 220 of the second embodiment of the invention.

FIG. 10 is a diagram showing the configuration of the region determining unit 2231 of the overdrive computing unit 223 according to the second embodiment illustrated in FIG. 9.

FIG. 11 is a diagram showing the configuration of the overdrive computing unit 223 of the display driver 220 of a third embodiment of the invention.

FIG. 12 is a block diagram showing the display driver 220 and peripheral devices of the third embodiment of the invention including the overdrive computing unit 223 illustrated in FIG. 11.

FIG. 13 is a diagram for explaining region division of a screen in a liquid crystal display device according to a fourth embodiment of the invention mounted on a cellular phone terminal.

FIG. 14 is a diagram showing the configuration of the overdrive computing unit 223 of the display driver 220 of the fourth embodiment of the invention.

### DETAILED DESCRIPTION OF THE PREFERRED EMBODIMENTS

### 1. Summary of the Preferred Embodiments

First, outline of representative embodiments of the invention disclosed in the application will be described. Reference numerals in drawings in parentheses referred to in description of the outline of the representative embodiments just denote components included in the concept of the components to which the reference numerals are designated.

[1] A representative embodiment of the invention relates to a display driver (220) capable of driving a display device (230).

The display driver (220) can store, in a memory (224), image display data which has been compressed, and can generate a preceding frame by decompressing the data read from the memory (224).

The display driver (220) includes a setting unit (222) and an overdrive computing unit (223).

The setting unit (222) can divide a display screen (102) of the display device (230) into at least first and second regions (105) and (106).

The overdrive computing unit (223) can generate overdrive display data in response to a present-time frame which is supplied and the preceding frame.

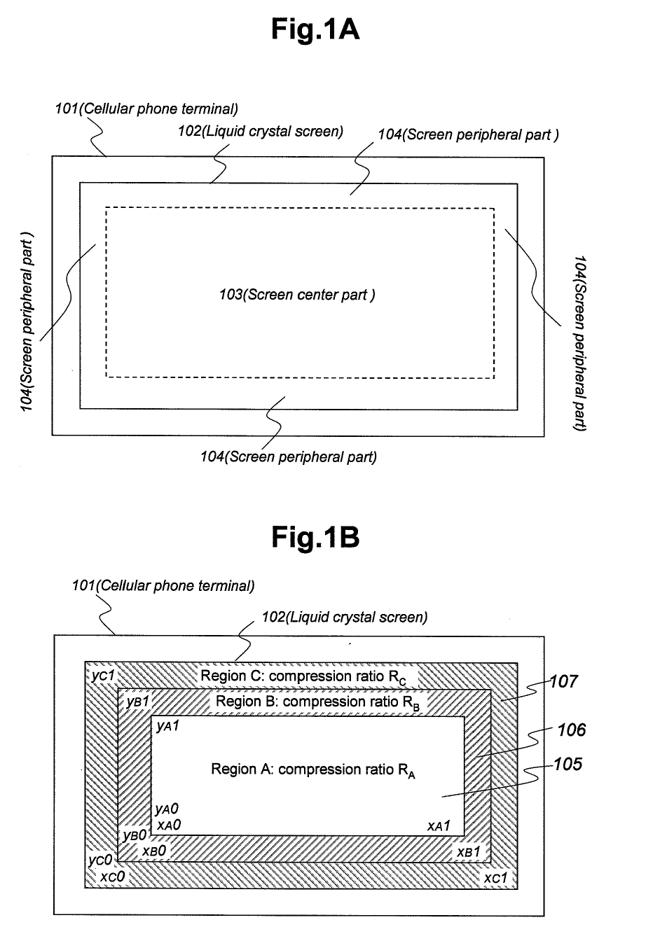

The overdrive computing unit (223) compresses image display data in the first region (105) and image display data in the second region (106) at a first data compression ratio (R_{A}) and a second data compression ratio (R_{B}) which are different from each other, respectively, and can store the compressed data into the memory (224) (refer to FIGS. 1, 2, 3, 4, 5, 6, and 7).

According to the embodiment, the efficiency in use of the memory for storing display data of preceding frame pixels to be used for the overdrive process can be improved.

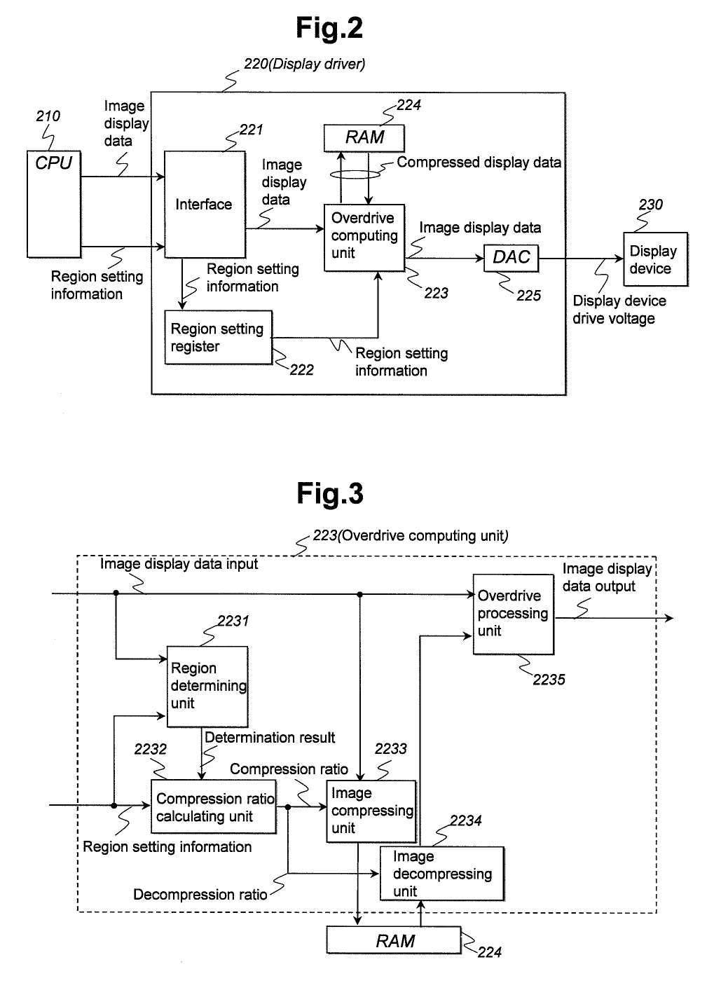

In a preferred embodiment, the overdrive computing unit (223) generates the overdrive display data including an overshoot and an undershoot responding to the difference between the present-time frame and the preceding frame (refer to FIGS. 2 and 3).

In another preferred embodiment, the overdrive computing unit (223) includes an image compressing unit (2233) and an image decompressing unit (2234).

The image compressing unit (2233) compresses the image display data stored in the memory (224). On the other hand, the image decompressing unit (2234) decompresses the data read from the memory (224).

The image compressing unit (2233) compresses the image display data in the first region (105) and the image display data in the second region (106) at the first data compression ratio (R_{A}) and the second data compression ratio (R_{B}) which are different from each other, respectively, and stores the compressed data into the memory (224) (refer to FIGS. 1, 2, and 3).

In another preferred embodiment, the overdrive computing unit (223) further includes a region determining unit (2231).

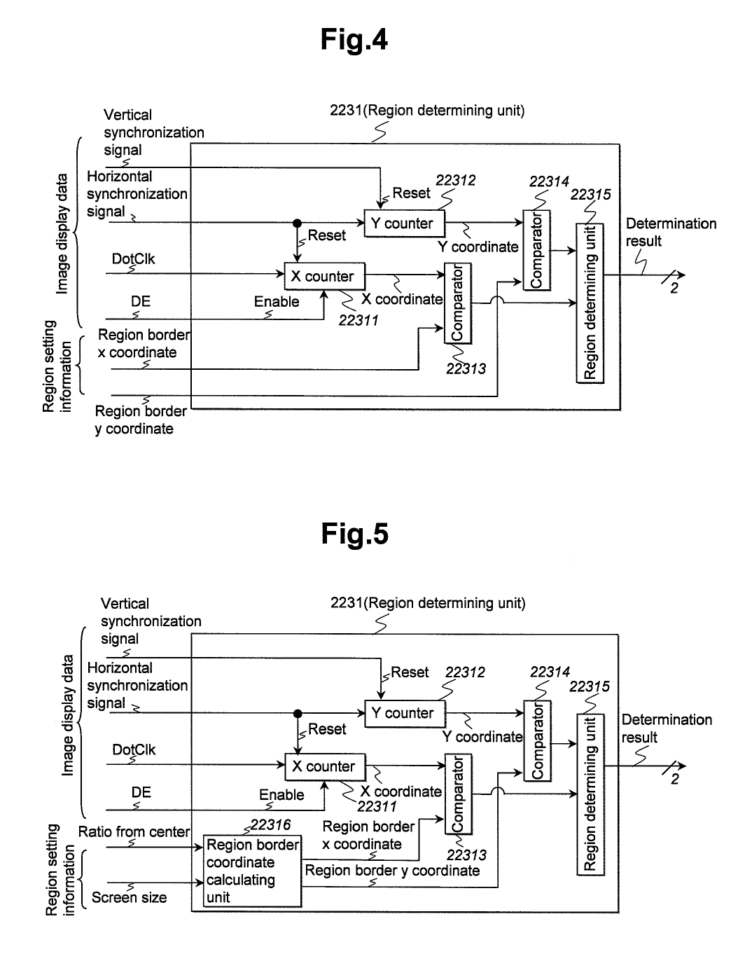

The region determining unit (2231) determines the first region (105) or the second region (106) to which the image display data belongs in response to a dot clock related to the image display data, a horizontal synchronization signal, and a vertical synchronization signal (refer to FIGS. 4 and 5).

In further another preferred embodiment, the overdrive computing unit (223) further includes a compression ratio calculating unit (2232).

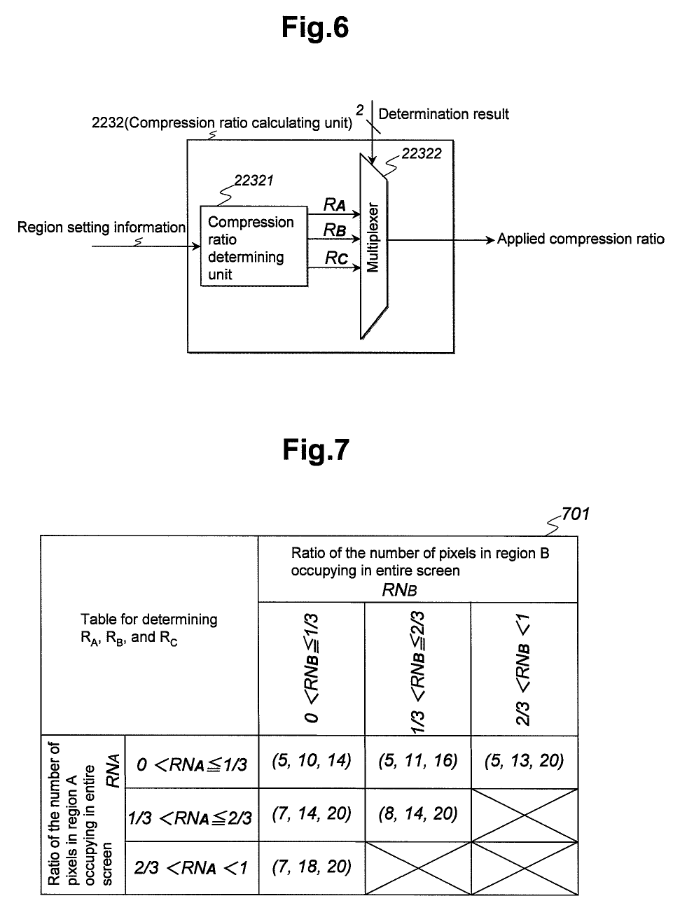

The compression ratio calculating unit (2232) calculates the first data compression ratio (R_{A}) and the second data compression ratio (R_{B}) in response to region setting information related to division between the first and second regions (105) and (106) of the display screen (102) of the display device (230) (refer to FIGS. 6 and 7).

In a concrete embodiment, the first and second regions (105) and (106) which are divided in the display screen (102) of the display device (230) can be set in an almost center of the display screen (102) and a periphery of the center, respectively.

The second data compression ratio (R_{B}) for the second region (106) of the periphery can be set to a value larger than the first data compression ratio (R_{A}) for the first region (105) of the almost center (refer to FIG. 1).

In another concrete embodiment, the first and second regions (105) and (106) divided on the display screen (102) of the display device (230) can be set to a region of center of visual field (108) of the display screen (102) detected by a line of sight of a viewer and a peripheral region, respectively.

The second data compression ratio (R_{B}) for the second region (106) as the peripheral region can be set to a value larger than that of the first data compression ratio (R_{A}) for the first region (105) as the region of the center of the visual field (108) (refer to FIG. 13).

The display driver (220) as the most concrete embodiment can drive a liquid crystal display device as the display device (230).

[2] A representative embodiment according to another aspect of the present invention relates to a driving method of a display driver (220) capable of driving a display device (230).

The display driver (220) compresses image display data, can store the compressed data in a memory (224), and can generate a preceding frame by decompressing the data read from the memory (224).

The display driver (220) comprises a setting unit (222) and an overdrive computing unit (223).

The setting unit (222) can divide a display screen (102) of the display device (230) into at least first and second regions (105) and (106).

The overdrive computing unit (223) can generate overdrive display data in response to a present-time frame to be supplied and the preceding frame.

The overdrive computing unit (223) compresses image display data in the first region (105) and image display data in the second region (106) at a first data compression ratio (R_{A}) and a second compression ratio (R_{B}) which are different from each other, respectively, and can store the compressed data into the memory (224) (refer to FIGS. 1, 2, 3, 4, 5, 6, and 7).

According to the embodiment, the efficiency in use of the memory for storing display data of pixels of a preceding frame which is used for an overdrive process can be improved.

### 2. Further Detailed Description of the Preferred Embodiments

The embodiments will be described more specifically. In all of the drawings for explaining the best mode for carrying out the invention, the same reference numerals are designated to the same parts having the same function as that in the drawings, and their description will not be repeated.

### First Embodiment

### <<Region Division of Liquid Crystal Screen>>

FIGS. 1A and 1B are diagrams for explaining region division of a screen in a liquid crystal display device according to a first embodiment of the invention mounted on a cellular phone terminal.

A cellular phone terminal 101 shown in FIG. 1A has a liquid crystal screen 102. In the liquid crystal screen 102, a region as a center portion of the screen will be called a screen center part 103, and a region in a periphery of the screen will be called a screen peripheral part 104. For example, a part obtained by eliminating 10% of length in the vertical direction of each of upper and lower ends and eliminating 10% of length in the horizontal direction of each of right and left ends may be set as the screen center part 103. The part other than the screen center part 103 in the liquid crystal screen 102 may be set as the screen peripheral part 104. The ratio of length and shapes of the center part and the peripheral part are an example, and the invention is not limited to the example. For example, the peripheral part may be provided only on right and left parts in the liquid crystal display 102.

In the first embodiment, it is assumed that, at the time of watching a motion picture by using the liquid crystal screen 102, in many cases, a viewer pays attention to the screen center part 103 but is not much interested in the picture quality of the screen peripheral part 104.

In the first embodiment, at the time of displaying a motion picture on the liquid crystal screen 102, the overdrive process is executed to reduce a motion blur. For this purpose, in the first embodiment, preceding frame data is stored in the screen center part 103 at higher precision (lower compression ratio) as compared with the screen peripheral part 104, and the overdrive process is executed, thereby making the picture quality in the screen center part 103 higher than that in the screen peripheral part 104. Therefore, when the picture quality in the screen center part 103 to which attention is paid improves, the viewer feels that the picture quality improves more effectively than in the case of executing the uniform overdrive process on the entire screen.

FIG. 1B is a diagram explaining that different precisions (compression ratios) are applied to the divided regions in the first embodiment of the invention. Since display data of the preceding frame is used in order to execute the overdrive process, it is necessary to store the display data. To reduce the memory to be mounted, the display data is compressed and stored in the frame memory. Generally, in the same compressing method, when the compression ratio is high, that is, when the compressed data amount is small, a small memory amount is sufficient. However, the error between data after decompression and data before compression becomes large, precision of display data becomes lower, and the picture quality deteriorates.

In the first embodiment of the present invention shown in FIG. 1B, the liquid crystal screen 102 is divided into three regions 105, 106, and 107. Display data is compressed at a compression ratio which varies among pixels in the three regions 105, 106, and 107, and the compressed data is stored. The division number and shapes of regions in the liquid crystal screen 102 shown in FIG. 1B are an example and do not limit the invention. The lowest compression ratio R_{A} is used in the region A (105) closest to the center. The compression ratio R_{B} higher than the compression ratio R_{A} is used in the peripheral region B (106), and the compression ratio R_{C} higher than the compression ratio R_{B} is used in the peripheral region C (107). The region A (105) in FIG. 1B almost corresponds to the screen center part 103 in FIG. 1A, and the region B (106) and the region C (107) in FIG. 1B almost correspond to the screen peripheral part 104 in FIG. 1A.

With the arrangement, the picture quality in the screen center part 103 in FIG. 1A to which the viewer pays attention becomes higher than that in the screen peripheral part 104 in FIG. 1A to which attention is paid less. The picture quality in the screen center part improves more than the case of mounting a frame memory of the same capacity and applying the uniform compression ratio to the entire screen. The effect can be realized also in the case where, without dividing the region of the liquid crystal screen 102 into three regions, the region is divided into, for example, two regions, and the compression ratios R_{A} and R_{B} are applied to the center region A (105) and the peripheral region B (106) as the divided two regions, respectively. By increasing the region division number, the change amount of picture quality in the border between the divided regions can be suppressed, and a feeling of strangeness in the border portion can be lessened.

### <<Configuration of Liquid Crystal Display Device Mounted On Cellular Phone Terminal>>

FIG. 2 is a block diagram showing the display driver of the first embodiment of the invention and peripheral devices.

As shown in FIG. 2, a display driver 220 according to the first embodiment of the invention receives image display data from a central processing unit (CPU) 210, executes overdrive computation by an overdrive computing unit 223 on the inside, and outputs drive voltage for driving a display device 230. To execute the overdrive process at the compression ratios which are different among the divided regions as shown in FIGS. 1A and 1B, the display driver 220 receives region setting information from the CPU 210. The display driver 220 shown in FIG. 2 includes an interface 221, a region setting register 222, an overdrive computing unit 223, a RAM 224 as a frame memory, and a D/A converter 225.

The display driver 220 shown in FIG. 2 is constructed, concretely, in the form of an LCD controller driver made by a CMOS monolithic semiconductor integrated circuit. In the case where the size of the liquid crystal screen 102 of the display device 230 is small, the RAM 224 as a frame memory is constructed by a built-in memory of an LCD controller driver. However, in the case where the size of the liquid crystal screen 102 of the display device 230 is large, a synchronous SRAM of large capacity on the outside of the LCD controller driver is used as the RAM 224 as a frame memory. <<Operation of Liquid Crystal>>

Now, outline of the operation on the inside of the display driver 220 shown in FIG. 2 will be described below.

Image display data supplied from the CPU 210 is supplied to the overdrive computing unit 223 via the interface 221. The overdrive computing unit 223 compresses image display data supplied from the CPU 210 via the interface 221 and stores the compressed data in the RAM 224. Further, the overdrive computing unit 223 generates display data of a result of the overdrive process by comparing the image display data supplied and image display data of the same pixel in a preceding frame stored in the RAM 224, and outputs it as drive voltage to the display device 230 via the D/A converter 225.

On the other hand, the region setting information supplied from the CPU 210 via the interface 221 is stored in the region setting register 222. Therefore, by referring to the region setting information stored in the region setting register 222, the overdrive computing unit 223 can determine the divided region to which the supplied image display data belongs from the divided regions 105, 106, and 107 in FIG. 1B, and execute the overdrive computation at a compression ratio which varies according to a region to which the data belongs.

### <<Overdrive Computing Unit>>

FIG. 3 is a diagram showing the configuration of the overdrive computing unit 223 of the display driver 220 of the first embodiment of the invention illustrated in FIG. 2.

The overdrive computing unit 223 shown in FIG. 3 includes a region determining unit 2231, a compression ratio calculating unit 2232, an image compressing unit 2233, an image decompressing unit 2234, and an overdrive processing unit 2235.

The operation of the overdrive computing unit 223 shown in FIG. 3 will be described below.

First, the region determining unit 2231 obtains the region setting information with reference to the region setting register 222 in the display driver 220 shown in FIG. 2. As the region setting information, the ratio in the vertical direction and that in the horizontal direction from the center of the liquid crystal screen 102 may be designated, and a predetermined region can be designated by coordinates. In such a manner, the region determining unit 2231 can determine the region to which a pixel corresponding to the supplied image display data belongs, from the region A (105), B (106), and C (107) in FIG. 1A.

Further, the compression ratio calculating unit 2232 sets the plurality of data compression ratios (R_{A}, R_{B}, and R_{C}) corresponding to the plurality of regions A, B, and C (105, 106, and 107) in the image compressing unit 2233. On the other hand, a plurality of decompression ratios equal to the plurality of data compression ratios (R_{A}, R_{B}, and R_{C}) are set in the image decompressing unit 2234.

### <<Region Determining Unit>>

FIG. 4 is a diagram showing the configuration of the region determining unit 2231 of the overdrive computing unit 223 illustrated in FIG. 3.

The region determining unit 2231 shown in FIG. 4 is constructed by an x counter 22311, a y counter 22312, comparators 2313 and 22314, and a region determining unit 22315.

The operation of the region determining unit 2231 shown in FIG. 4 will be described below.

First, the image display data supplied from the CPU 210 to the display driver 220 shown in FIG. 2 includes a vertical synchronization signal, a horizontal synchronization signal, a data enable DE, a dot clock DotClk, and pixel data indicative of gray levels of pixels. Image display data supplied to the region determining unit 2231 shown in FIG. 4 includes the vertical synchronization signal, the horizontal synchronization signal, the data enable DE, and the dot clock DotClk except for the pixel data indicative of the gray level of each pixel. Further, the region setting information supplied from the CPU 210 via the region setting register 222 to the region determining unit 2231 shown in FIG. 4 includes a region border x coordinate and a region border y coordinate.

In the region determining unit 2231 shown in FIG. 4, the x counter 22311 which is reset by the horizontal synchronization signal to be enabled by the data enable DE counts the number of pixels on the basis of the number of pulses of the dot cock DotClk supplied, and outputs the x coordinate of the pixel which is presently supplied. On the other hand, the y counter 22312 which is reset by the vertical synchronization signal counts the horizontal synchronization signal and outputs the y coordinate of the pixel which is presently supplied. The presently-supplied x coordinate and the y coordinate output from the x counter 22311 and the y counter 22312 are compared with a region border x coordinate and a region border y coordinate in the region setting information by the comparators 22313 and 22314, respectively. From a result of the comparison of the two comparators 22313 and 22314, the region determining unit 22315 determines the region A (105), B (106), or C (107) shown in FIG. 1B to which the presently-supplied pixel belongs. For example, when the x coordinate of a pixel being input lies in the range between the x coordinates x_{A}0 and x_{A}1 of the border of the region A (105) and the y coordinate lies in the range between the y coordinates y_{A}0 and y_{A}1 of the border of the region A (105), it can be determined that the pixel being input belongs to the region A (105). Similarly, when the x coordinate of a pixel being input lies in the range between the x coordinates x_{B}0 and x_{B}1 of the border of the region B (106) and the y coordinate lies in the range between the y coordinates y_{B}0 and y_{B}1 of the border of the region B (106) and it is determined that the pixel being input does not belong to the region A (105), it can be determined that the pixel being input belongs to the region B (106). Similarly, when the x coordinate of a pixel being input lies in the range between the x coordinates x_{C}0 and x_{C}1 of the border of the region C (107), the y coordinate lies in the range between the y coordinates y_{C}0 and y_{C}1 of the border of the region B (106), and it is determined that the pixel being input does not belong to the region B (106), it can be determined that the pixel being input belongs to the region C (107). The determination algorithm is an example, and the invention is not limited to the algorithm. In such a manner, the region determining unit 2231 shown in FIG. 4 outputs a result of determination of two bits indicative of a region, which is any of the region A (105), the region B (106), and the region C (107) shown in FIG. 1B, to which a pixel being input belongs.

When the compressing method of the image compressing unit 2233 in the overdrive computing unit 223 in FIG. 3 is discrete cosine transform (DCT), the values of the region border x coordinate and the region border y coordinate stored in the region setting register 222 and referred to by the region determining unit 2231 are set according to the DCT unit. For example, in the case where the DCT unit is 2 pixels×2 pixels, the value is a coordinate interval of multiples of 2. Similarly, in the case where the DCT unit is 4 pixels×4 pixels, the value is a coordinate interval of multiples of 4.

FIG. 5 is a diagram showing another configuration of the region determining unit 2231 of the overdrive computing unit 223 illustrated in FIG. 3.

The region determining unit 2231 shown in FIG. 5 is constructed by, like the region determining unit 2231 shown in FIG. 4, the x counter 22311, the y counter 22312, the comparators 2313 and 22314, and the region determining unit 22315. On the other hand, to the region determining unit 2231 shown in FIG. 5, a region border coordinate calculating unit 22316 is added.

To the region border coordinate calculating unit 22316 in the region determining unit 2231 shown in FIG. 5, the percentages in the vertical and horizontal directions from the center of the liquid crystal screen 102 and the screen size of each of the region A (105), the region B (106), and the region C (107) shown in FIG. 1B are supplied as region setting information. Therefore, in the border coordinate calculating unit 22316, the screen size and the ratio from the screen center of each of the region A (105), the region B (106), and the region C (107) are multiplied, thereby generating border x coordinates x_{A}0 and x_{A}1 and border y coordinates y_{A}0 and y_{A}1 of the region A (105), border x coordinates x_{B}0 and x_{B}1 and border y coordinates y_{B}0 and y_{B}1 of the region B (106), and border x coordinates x_{C}0 and x_{C}1 and border y coordinates y_{C}0 and y_{C}1 of the region C (107). As a result, the region border x coordinates and the region border y coordinates are generated from the region border coordinate calculating unit 22136 and supplied to the comparators 22313 and 22314.

### <<Compression Ratio Calculating Unit>>

FIG. 6 is a diagram showing the configuration of the compression ratio calculating unit 2232 of the overdrive computing unit 223 illustrated in FIG. 3.

The compression ratio calculating unit 2232 shown in FIG. 6 includes a compression ratio determining unit 22321 and a multiplexer 22322.

The compression ratio determining unit 22321 in the compression ratio calculating unit 2232 shown in FIG. 6 determines the data compression ratios R_{A}, R_{B}, and R_{C} to be applied to the regions A (105), B (106), and C (107) shown in FIG. 1B, respectively, on the basis of the region setting information provided from the region setting register 222. According to the determination result of two bits of the region determining unit 2231, the multiplexer 22322 selects one data compression ratio from the data compression ratios R_{A}, R_{B}, and R_{C} as a compression ratio applied to a pixel being input, and outputs it.

Next, a method of determining the data compression ratios R_{A}, R₃, and R_{C} applied to the regions A (105), B (106), and C (107) shown in FIG. 1B will be described below.

The capacity of the RAM 224 as a frame memory of the display driver 220 shown in FIG. 2 is set as Dmemory, the number of pixels belonging to a region designated as the region A (105) shown in FIG. 1B is set as N_{A}, the number of pixels belonging to a region designated as the region B (106) shown in FIG. 1B is set as N_{B}, the number of pixels belonging to a region designated as the region C (107) shown in FIG. 1B is set as N_{C}, and an input image data amount included in one pixel is set as Din. The data compression ratios R_{A}, R_{B}, and R_{C} applied to the regions A (105), B (106), and C (107) are determined so as to satisfy the following formula (1).

$$Dmemory \geq Din \times {N}_{A} \times \frac{1}{{R}_{A}} + Din \times {N}_{B} \times \frac{1}{{R}_{B}} + Din \times {N}_{C} \times \frac{1}{{R}_{C}} \qquad ( 1 )$$

The data compression ratio is the ratio between the data size before compression and the data size after compression. The higher the data compression ratio is, the smaller the size of data after compression becomes. When the data compression ratios R_{A}, R_{B}, and R_{C} are set as low as possible in the range satisfying the formula (1), the picture quality in an application region improves. When the data compression ratio R_{A} is set to low, the picture quality in the region A (105) improves and, on the other hand, the picture quality in the other regions B (106) and C (107) deteriorates.

Next, a method of determining the data compression ratios R_{A}, R_{B}, and R_{C} on display data of pixels in the regions A (105), B (106), and C (107) shown in FIG. 1B will be described.

FIG. 7 is a diagram showing the configuration of a compression ratio table 701 included in the compression ratio determining unit 22321 of the compression ratio calculating unit 2232 illustrated in FIG. 6.

By supply of the region designation information from the region setting register 222 to the compression ratio calculating unit 2232 shown in FIG. 6, the compression ratio determining unit 22321 calculates the ratio RN_{A} of the number of pixels belonging to the region A (105) in FIG. 1B occupying the whole and the ratio RN_{B} of the number of pixels belonging to the region B (106) in FIG. 1B occupying the whole, from the region designation information.

On the other hand, as shown in FIG. 7, the compression ratio table 701 included in the compression ratio determining unit 22321 is matrix data formed by three entries in the vertical direction and three entries in the horizontal direction.

In the vertical direction, the first entry corresponds to the case where the occupying ratio RN_{A} of the number of pixels of the region A (105) is a relatively small value satisfying 0<RN_{A}≦⅓. The second entry corresponds to the case where the occupying ratio RN_{A} of the number of pixels of the region A (105) is an intermediate value satisfying ⅓<RN_{A}≦⅔. The third entry corresponds to the case where the occupying ratio RN_{A} of the number of pixels of the region A (105) is a relatively large value satisfying ⅔<RN_{A}≦1.

Similarly, in the horizontal direction, the first entry corresponds to the case where the occupying ratio RN_{B} of the number of pixels of the region B (106) is a relatively small value satisfying 0<RN_{B}≦⅓. The second entry corresponds to the case where the occupying ratio RN_{B} of the number of pixels of the region B (106) is an intermediate value satisfying ⅓<RN_{B}≦⅔. The third entry corresponds to the case where the occupying ratio RN_{B} of the number of pixels of the region B (106) is a relatively large value satisfying ⅔<RN_{B}≦1.

Therefore, one entry is selected from the three entries in the vertical direction of the compression ratio table 701 in accordance with the occupying ratio RN_{A} of the number of pixels calculated by the compression ratio calculating unit 2232, and one entry is selected from the three entries in the horizontal direction of the compression ratio table 701 in accordance with the occupying ratio RN_{B} of the number of pixels calculated by the compression ratio calculating unit 2232

For example, in the case where the first entry in the vertical direction is selected according to the occupying ratio RN_{A} of the number of pixels calculated by the compression ratio determining unit 22321 and the second entry in the horizontal direction is selected in accordance with the occupying ratio RN_{B} of the number of pixels calculated by the compression ratio determining unit 22321, the compression ratios R_{A}, R_{B}, and R_{C} of combination data (5, 11, 16) are selected in the compression ratio table 701.

That is, in the case where the occupying ratio RN_{A} of the number of pixels of the region A (105) is a relatively small and the occupying ratio RN_{B} of the number of pixels of the region B (106) is an intermediate value, the data compression ratio R_{A} of the region A (105) is set to the minimum value like five, the data compression ratio R_{B} of the region B (106) is set to a relatively small value like “11”, and the data compression ratio R_{C} of the region C (107) is set to a relatively large value of “16”.

When the occupying ratio RN_{A} of the number of pixels of the region A (105) increases, the data compression ratio R_{A} of the region A (105) increases from the minimum value “5” to the intermediate value “7”. When the occupying ratio RN_{B} of the region B (106) increases, the data compression ratio R_{B} of the region B (106) increases from “11” as the relatively small value to “14” as the intermediate value. In such a case, the data compression ratio R_{C} of the region C (107) increases from a relatively large value of “16” to the maximum value “20”.

Another method of determining the data compression ratios R_{A}, R_{B}, and R_{C} on display data of pixels in the regions A (105) B (106), and C (107) shown in FIG. 1B will be described.

In the another determining method, the ratio of the data compression ratios R_{A}/R_{B} and R_{B}/R_{C} applied to two neighboring regions A (105) and B (106), and two neighboring regions B (106) and C (107) satisfies a predetermined condition. When the ratio is set as 1/k, the condition is given by the following formula (2). To satisfy the condition of the following formula (2) and the condition of the above formula (1), the data compression ratios R_{A}, R_{B}, and R_{C} have to be set like the following formulae (3), (4), and (5). When a constant k is set as above (for example, k=2), the data compression ratios R_{A}, R_{B}, and R_{C} can be determined so as to have equality in the formula (2). It can produce an effect that a picture quality change in the border between regions is prevented from being concentrated on a part of borders.

$$\begin{matrix}\frac{{R}_{A}}{{R}_{B}} = \frac{{R}_{B}}{{R}_{C}} = \frac{1}{k} & ( 2 ) \\ {R}_{A} \geq \frac{Din}{{k}^{2} * Dmemory} ( {k}^{2} * {N}_{A} + k * {N}_{B} + {N}_{C} ) & ( 3 ) \\ {R}_{B} \geq \frac{Din}{k * Dmemory} ( {k}^{2} * {N}_{A} + k * {N}_{B} + {N}_{C} ) & ( 4 ) \\ {R}_{C} \geq \frac{Din}{Dmemory} ( {k}^{2} * {N}_{A} + k * {N}_{B} + {N}_{C} ) & ( 5 )\end{matrix}$$

Further, another method of determining the data compression ratios R_{A}, R_{B}, and R_{C} on display data of pixels in the regions A (105), B (106), and C (107) shown in FIG. 1B will be described.

In the another determining method, the compression ratios R_{B} and R_{C} applied to display data of pixels belonging to the regions B (106) and C (107) as peripheral regions are fixed. On the other hand, the compression ratio R_{A} on display data of pixels belonging to the center region A (105) is minimized according to the ratio of the numbers N_{A}, N_{B}, and N_{C} of pixels in the regions A (105), B (106), and C (107). The following formulae (6), (7), and (8) will explain the method.

$$\begin{matrix}{R}_{B} = {R}_{B} ( max ) & ( 6 ) \\ {R}_{C} = {R}_{C ( max )} & ( 7 ) \\ {R}_{A} \geq \frac{{N}_{A}}{\frac{Dmemory}{Din} - \frac{{N}_{B}}{{R}_{B}} - \frac{{N}_{C}}{{R}_{C}}} & ( 8 )\end{matrix}$$

The formulae (6) and (7) express that the data compression ratios R_{B} and R_{C} are set to the maximum data compression ratios R_{B(max)} and R_{C(max)}, respectively, so as to obtain permissible picture quality in the regions B (106) and C (107) in the peripheral part. To satisfy both the setting conditions by the formulae (6) and (7) and the condition of the formula (1), the data compression ratio R_{A} is set as shown by the formula (8). In the formula (8), Dmemory denotes the storage capacity of the RAM 224 as a frame memory, Din denotes an input image data amount included in each pixel, N_{A} denotes the number of pixels belonging to the region A (105), and N_{B} indicates the number of pixels belonging to the region B (106).

When the compression ratio R_{A} on the region A (105) is set so as to have equality in the formula (8), the picture quality in the region A (105) in the center portion becomes the highest under the condition of the formula (8).

### <<Operation of Overdrive Computing Unit>>

Referring again to FIG. 3, the operation of the overdrive computing unit 223 shown in FIG. 3 will be described below.

The image display data supplied from the CPU 210 to the display driver 220 of the first embodiment is supplied first to the region determining unit 2231. Therefore, the region determining unit 2231 determines the region A (105) as the center region or the region B (106) or the region C (107) as the peripheral region of the liquid crystal screen 102 shown in FIG. 1B to which the supplied image display data belongs. A result of the determination of the region determining unit 2231 is supplied to the compression ratio calculating unit 2232 and, on the other hand, the image display data supplied from the CPU 210 is supplied to the image compressing unit 2233. In the case where the determination results of the region determining unit 2231 are the region A (105), the region B (106), and the region C (107), the compression ratio calculating unit 2232 sets the values of the data compression ratios R_{A}, R_{B}, and R_{C} in the image compressing unit 2233 in accordance with the determination results. The image compressing unit 2233 compresses the display data in accordance with the data compression ratio set by the compression ratio calculating unit 2232 and stores the compressed display data into the frame memory 224.

The image data stored in the frame memory 224 is read from the frame memory 224 at a timing when image data of the same pixel of the following frame is supplied from the interface 221 to the overdrive computing unit 223, and decompressed by the image decompressing unit 2234. On the other hand, the image data of the same pixel in the following frame supplied to the display driver 220 of the first embodiment is compared with the image data of the preceding frame decompressed by the image decompressing unit 2234 in the overdrive processing unit 2235, thereby generating image data for overdrive.

By generating the image display output data from the image display input data as described above, around the screen center part 103 of the liquid crystal screen 102 in FIG. 1A, the liquid crystal is driven by the image data for the overdrive process generated by using the preceding frame data of low compression ratio and high precision. On the other hand, in the region of the screen peripheral part 104 far from the center of the liquid crystal screen 102, the liquid crystal is driven by the image data for overdrive process generated by using the preceding frame data of high compression ratio and low precision. Therefore, in the first embodiment, by storing the preceding frame data at higher precision (lower compression ratio) in the screen center part 103 as compared with that in the screen peripheral part 104 and executing the overdrive process, the picture quality in the screen center part 103 is made higher relative to that in the screen peripheral part 104. As a result, by improvement in picture quality in the screen center part 103 to which attention is paid, the viewer feels that the picture quality improves more effectively than in the case where the uniform overdrive process is executed in the entire screen.

### Second Embodiment

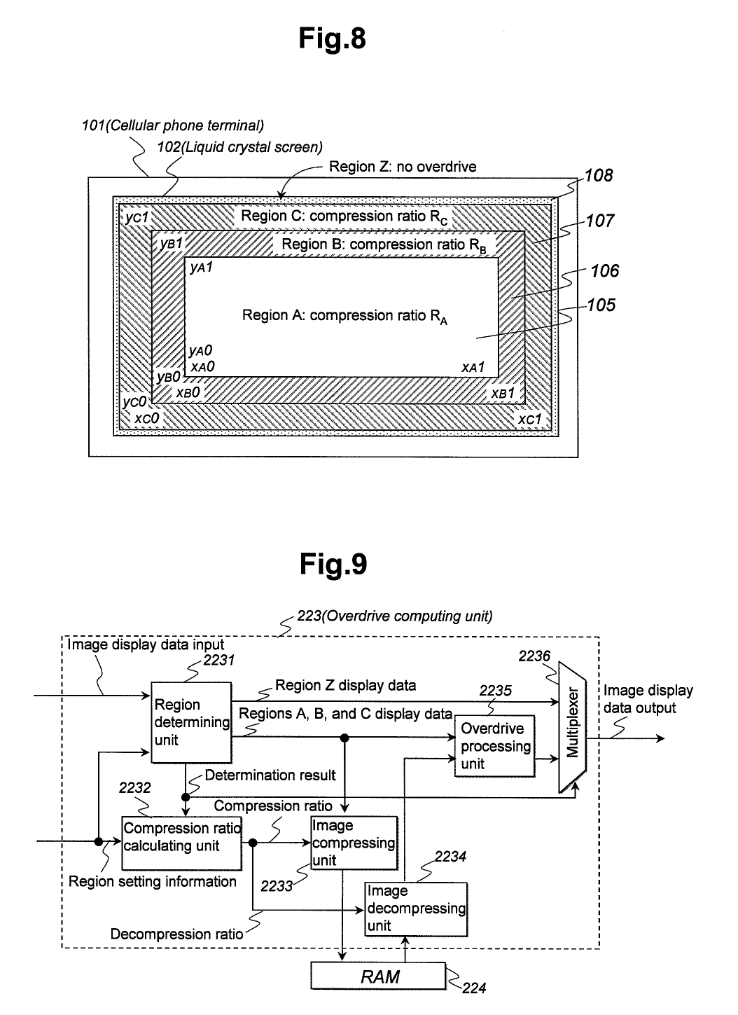

FIG. 8 is a diagram for explaining region division of a screen in a liquid crystal display device according to a second embodiment mounted on a cellular phone terminal.

In the region division of the liquid crystal screen in the second embodiment shown in FIG. 8, a fourth region Z (108) is added to the three regions A (105), B (106), and C (107) of the liquid crystal screen according to the first embodiment shown in FIG. 1. However, in the second embodiment shown in FIG. 8, the overdrive process is not performed on pixels belonging to the added fourth region Z (108). That is, on the pixels belonging to the fourth region Z (108), data compression of the image compressing unit 2233 of the overdrive computing unit 223, storage to the frame memory 224, and data decompression of the image decompressing unit 2234 are not performed. As a result, storage capacity of the frame memory 224 can be saved with respect to the pixels in the periphery region Z (108) in the outermost periphery of the liquid crystal screen 102 in which the viewer is less interested. The saved storage capacity can be assigned to the overdrive process on the pixels belonging to the three regions A (105), B (106), and C (107) of the liquid crystal screen. Therefore, the picture quality in the three regions A (105), B (106), and C (107) in the liquid crystal screen can be improved by the amount of the storage capacity of the outermost-peripheral region Z (108) in the liquid crystal screen 102.

FIG. 9 is a diagram showing the configuration of the overdrive computing unit 223 of the display driver 220 of the second embodiment of the invention.

The overdrive computing unit 223 according to the second embodiment shown in FIG. 9 includes, like the overdrive computing unit 223 according to the first embodiment shown in FIG. 3, the region determining unit 2231, the compression ratio calculating unit 2232, the image compressing unit 2233, the image decompressing unit 2234, and the overdrive processing unit 2235. To the overdrive computing unit 223 in FIG. 9, a multiplexer 2236 is added. Further, in the overdrive computing unit 223 according to the second embodiment shown in FIG. 9, display data belonging to the regions A (105), B (106), and C (107) in FIG. 8 generated from one of output terminals of the region determining unit 2231 is supplied to one of input terminals of the multiplexer 2236 via the overdrive processing unit 2235. Display data belonging to the outermost peripheral region Z (108) in FIG. 8 generated from the other output terminal of the region determining unit 2231 is directly supplied to the other input terminal of the multiplexer 2236, and a determination result generated from the region determining unit 2231 is supplied to the control input terminal of the multiplexer 2236.

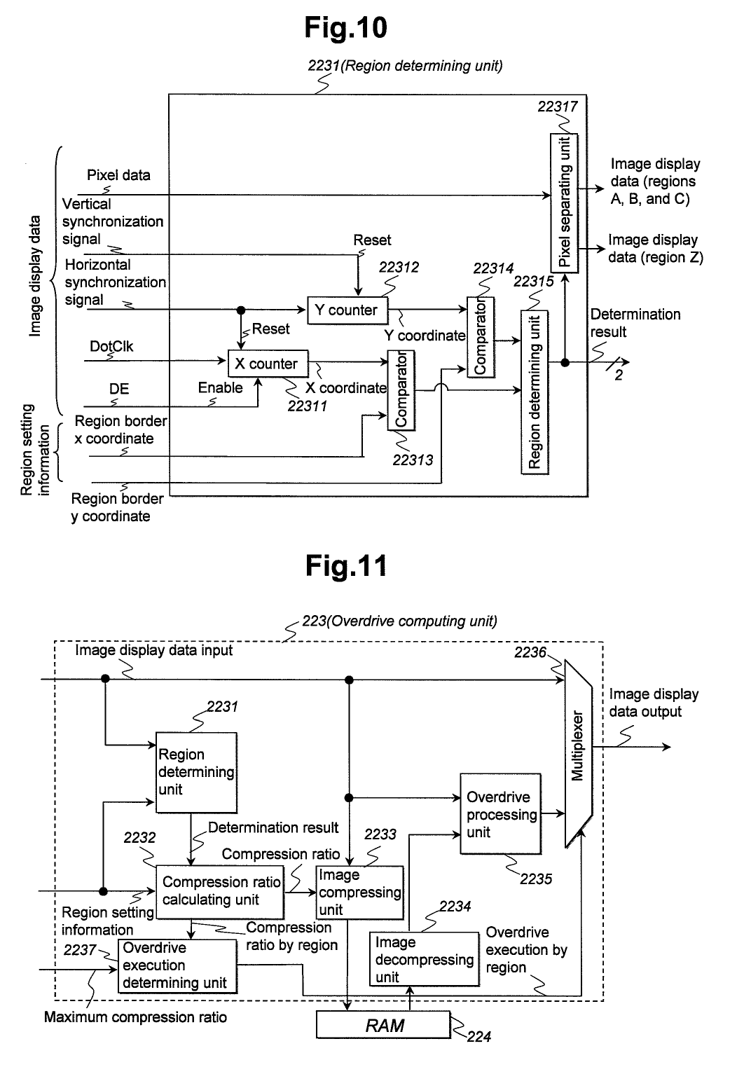

FIG. 10 is a diagram showing the configuration of the region determining unit 2231 of the overdrive computing unit 223 according to the second embodiment illustrated in FIG. 9.

The region determining unit 2231 according to the second embodiment shown in FIG. 10 includes, like the region determining unit 2231 according to the first embodiment shown in FIG. 4, the x counter 22311, the y counter 22312, the comparators 22313 and 22314, and the region determining unit 22315. To the region determining unit 2231 in FIG. 10, a pixel separating unit 22317 is added. Further, to the pixel separating unit 22137, pixel data indicative of gray levels of pixels in the region A (105), the region B (106), the region C (107), and the region Z (108) in FIG. 8 is supplied as image display data. A result of determination of two bits of the region determining unit 22315 is supplied to the control input terminal of the pixel separating unit 22137. Therefore, display data belonging to the regions A (105), B (106), and C (107) in FIG. 8 is generated from one of the output terminals of the pixel separating unit 22317 in the region determining unit 2231, and display data belonging to the outermost periphery region Z (108) in FIG. 8 is generated from the outer output terminal of the pixel separating unit 22317.

Referring again to FIG. 9, the operation of the overdrive computing unit 223 shown in FIG. 9 will be described below.

The image display data supplied from the CPU 210 to the display driver 220 of the second embodiment is supplied first to the region determining unit 2231. Therefore, the region determining unit 2231 determines the region to which the supplied image display data belongs from the region A (105), the region B (106), the region C (107), and the region Z (108) shown in FIG. 8. The determination result of the region determining unit 2231 is supplied to both of the compression ratio calculating unit 2232 and the multiplexer 2236. In the case where the supplied image display data is a pixel belonging to any of the regions A (105), B (106), and C (107) in FIG. 8, display data generated from one of the output terminals of the region determining unit 2231 is supplied to the image compressing unit 2232 and the overdrive processing unit 2235. In the compression ratio calculating unit 2232, in the case where a determination result of the region determining unit 2231 indicates the region A (105), B (106), or C (107), any of the data compression ratios R_{A}, R_{B}, and R_{C} is set in the image compressing unit 2233 according to the determination result. The image compressing unit 2233 compresses the display data supplied from one of output terminals of the region determining unit 2231 at a data compression ratio which is set by the compression ratio calculating unit 2232, and the compressed data is stored in the frame memory 224. The image display data stored in the frame memory 224 is read from the frame memory 224 at a timing when image data of the same pixel of the following frame is supplied from the frame memory 224 and decompressed by the image decompressing unit 2234. On the other hand, the image display data of the same pixel in the following frame in the regions A (105), B (106), and C (107) via the region determining unit 2231 is compared with the pixel data of the preceding frame decompressed by the image decompressing unit 2234 in the overdrive processing unit 2235, thereby generating image display data for overdrive. On the other hand, in the case where the supplied image display data indicates display data belonging to the outermost peripheral region Z (108) in FIG. 8, display data in the region Z (108) in FIG. 8 generated from the other output terminal of the region determining unit 2231 is directly supplied to the other input terminal of the multiplexer 2236. In response to the determination result of the region determining unit 2231, the multiplexer 2236 selects one of data of the regions A (105), B (106), and C (107) supplied from one of the output terminals of the region determining unit 2231 and display data of the region Z (108) supplied from the other output terminal. The selected display data is supplied as image display data output to the D/A converter 225 of the display driver 202.

According to the second embodiment of the invention described above with reference to FIGS. 9 and 10, in a manner similar to the first embodiment, preceding frame data is stored in the screen center part 103 in the liquid crystal screen 102 at higher precision (lower compression ratio) as compared with that in the screen peripheral part 104, and the overdrive process is executed, thereby making the picture quality in the screen center part 103 relatively higher than that in the screen peripheral part 104. Further, storage capacity of the frame memory 224 can be saved with respect to the pixels in the periphery region Z (108) in the outermost periphery of the liquid crystal screen 102 in which the viewer is less interested. The picture quality in the screen center part 103 in the liquid crystal screen 102 can be improved by the saved amount.

### Third Embodiment

FIG. 11 is a diagram showing the configuration of the overdrive computing unit 223 of the display driver 220 of a third embodiment of the invention.

The overdrive computing unit 223 according to the third embodiment shown in FIG. 11 includes, like the overdrive computing unit 223 according to the second embodiment shown in FIG. 9, the region determining unit 2231, the compression ratio calculating unit 2232, the image compressing unit 2233, the image decompressing unit 2234, the overdrive processing unit 2235, and the multiplexer 2236. Further, to the overdrive computing unit 223 in FIG. 11, an overdrive execution determining unit 2237 is added. Further, in the overdrive computing unit 223 according to the third embodiment shown in FIG. 11, the values of the data compression ratios R_{A}, R_{B}, and R_{C} in the regions A (105), B (106), and C (107) in the liquid crystal screen 102 set in the image compressing unit 2233 are supplied to the overdrive execution determining unit 2237. To the overdrive execution determining unit 2237, the maximum compression ratios as the upper limits of the data compression ratios R_{A}, R_{B}, and R_{C} are supplied. Further, overdrive execution signals on the regions generated from an output of the overdrive execution determining unit 2237 are supplied to the control input terminal of the multiplexer 2236. To one of the input terminals of the multiplexer 2236 and the other input terminal, image display data and an output signal of the overdrive processing unit 2235 are supplied.

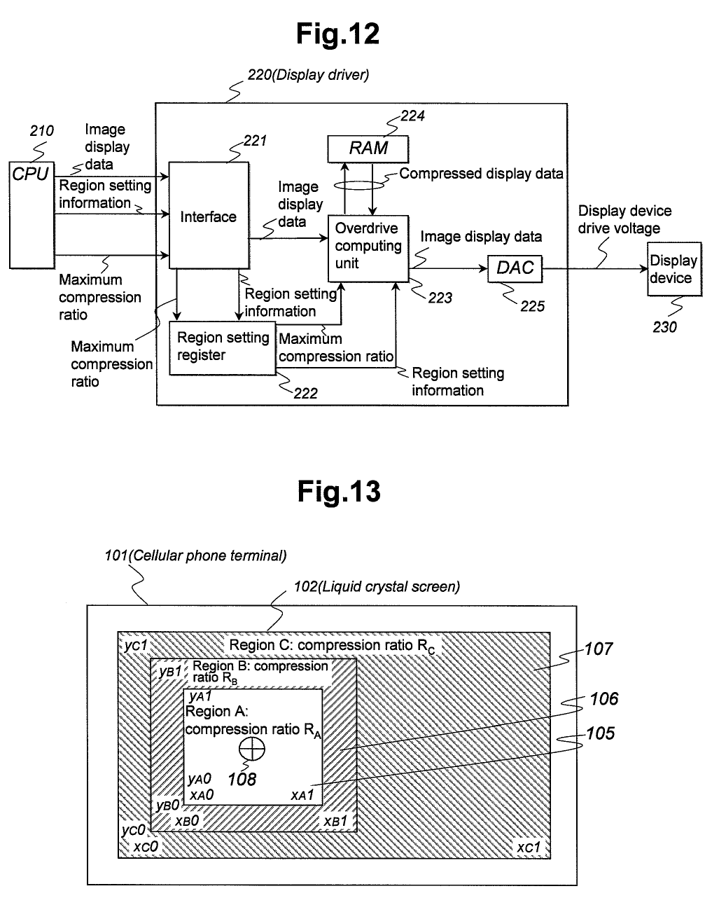

FIG. 12 is a block diagram showing the display driver 220 and peripheral devices of the third embodiment of the invention including the overdrive computing unit 223 illustrated in FIG. 11.

The display driver 220 shown in FIG. 12 includes, like the display driver 220 shown in FIG. 2, the interface 221, the register 222 for setting, the overdrive computing unit 223, the RAM 224 as a frame memory, and the D/A converter 225. In the display driver 220 shown in FIG. 12, the maximum compression ratios as the upper limits of the data compression ratios R_{A}, R_{B}, and R_{C} are supplied from the CPU 210 to the overdrive computing unit 223 via the interface 21 and the register 222 for setting.

In the third embodiment of the invention described with reference to FIGS. 9 and 10, when the values of the data compression ratios R_{A}, R_{B}, and R_{C} of the regions A (105), B (106) and C (107) in the liquid crystal screen 102 calculated by the compression ratio calculating unit 2232 in the overdrive computing unit 223 are less than the maximum compression ratios of the upper limits, operations similar to those of the first and second embodiments of the invention are executed. That is, preceding frame data is stored in the screen center part 103 in the liquid crystal screen 102 at higher precision (lower compression ratio) as compared with that in the screen peripheral part 104. By executing the overdrive process, the picture quality in the screen center part 103 can be made higher relative to that in the screen peripheral part 104.

However, when the values of the data compression ratios R_{A}, R_{B}, and R_{C} calculated by the compression ratio calculating unit 2232 in the overdrive computing unit 223 are equal to or larger than the maximum compression ratios of the upper limits, the overdrive process is not executed. That is, in this case, the multiplexer 2236 having a control input terminal to which an overdrive inhibit signal output from the overdrive execution determining unit 2237 is supplied selects image display data to be supplied to one of input terminals, and outputs the selected image display data as an output signal of the overdrive computing unit 223. Therefore, in the case where there is the possibility that deterioration in picture quality becomes conspicuous when the compression ratios R_{A}, R_{B}, and R_{C} calculated by the compression ratio calculating unit 2232 are set to excessively high values, the overdrive process is not performed, and image display data of relatively high quality supplied to the overdrive processing unit 2235 is selected by the multiplexer 2236 and is output as an output signal of the overdrive computing unit 223.

Referring again to FIG. 11, the operation of the overdrive computing unit 223 shown in FIG. 11 will be described below.

Image display data supplied from the CPU 210 to the display driver 220 of the third embodiment is supplied first to the region determining unit 2231. Therefore, the region determining unit 2231 determines the region to which the supplied image display data belongs from the region A (105), the region B (106), the region C (107), and the region Z (108) shown in FIG. 8. The determination result of the region determining unit 2231 is supplied to the compression ratio calculating unit 2232. In the case where the determination result of the region determining unit 2231 shows any of the regions A (105), B (106), and C (107), the compression ratio calculating unit 2232 sets any of the data compression ratios R_{A}, R_{B}, and R_{C} into the image compressing unit 2233 according to the determination result. The image compressing unit 2233 compresses the supplied image display data at a data compression ratio which is set by the compression ratio calculating unit 2232, and the compressed data is stored in the frame memory 224. The image display data stored in the frame memory 224 is read from the frame memory 224 at a timing when image display data of the same pixel of the following frame is input, and decompressed by the image decompressing unit 2234. On the other hand, the image display data of the same pixel in the following frame in the regions A (105), B (106), and C (107) is compared with the pixel data of the preceding frame decompressed by the image decompressing unit 2234 in the overdrive processing unit 2235, thereby generating image display data for overdrive.

On the other hand, the overdrive execution determining unit 2237 compares the data compression ratios R_{A}, R_{B}, and R_{C} calculated by the compression ratio calculating unit 2232 with the maximum data compression ratios R_{A}, R_{B}, and R_{C} as the upper limits which are set in the register 222 for setting.

In the case where the values of the data compression ratios R_{A}, R_{B}, and R_{C} calculated by the compression ratio calculating unit 2232 are less than the maximum compression ratios of the upper limits, the multiplexer 2236 having a control input terminal to which an overdrive enable signal output from the overdrive execution determining unit 2237 is supplied selects an output signal of the overdrive processing unit 2235 which is supplied to the other input terminal. The selected output signal is output as the output signal of the overdrive computing unit 223.

In the case where the values of the data compression ratios R_{A}, R_{B}, and R_{C} calculated by the compression ratio calculating unit 2232 in the overdrive computing unit 223 are equal to or larger than the maximum compression ratios of the upper limits, the multiplexer 2236 having a control input terminal to which an overdrive inhibit signal output from the overdrive execution determining unit 2237 is supplied selects image display data to be supplied to one of input terminals, and outputs the selected image display data as an output signal of the overdrive computing unit 223.

According to the third embodiment of the invention described above with reference to FIGS. 11 and 12, in a manner similar to the first and second embodiments, preceding frame data is stored in the screen center part 103 in the liquid crystal screen 102 at higher precision (lower compression ratio) as compared with that in the screen peripheral part 104, and the overdrive process is executed, thereby enabling the picture quality in the screen center part 103 to be relatively higher than that in the screen peripheral part 104. In the case where there is the possibility that deterioration in picture quality becomes conspicuous when the data compression ratios R_{A}, R_{B}, and R_{C} calculated by the compression ratio calculating unit 2232 are set to excessively high values, the overdrive process is not performed, and image display data of relatively high picture quality supplied to the overdrive processing unit 2235 is selected by the multiplexer 2236 and is output as an output signal of the overdrive computing unit 223.

### Fourth Embodiment

FIG. 13 is a diagram for explaining region division of a screen in a liquid crystal display device according to a fourth embodiment of the invention mounted on a cellular phone terminal.

In a method of dividing a screen to regions shown in FIG. 13, different from the method of dividing a screen to regions shown in FIGS. 1 and 8, the two regions A (105) and B (106) in which the relatively-low data compression ratios R_{A} and R_{B} are set are not set stationary in the screen center part 103 but change dynamically on the inside of the liquid crystal screen 102. On the other hand, the third region C (107) in which the data compression ratio RC of a relatively high value is set is set stationary in the screen center part 103.

In the screen shown in FIG. 13, reference numeral 108 denotes the center of view field detected by detection of the view line of the viewer of the screen. The center 108 of view field moves in the liquid crystal screen 102 in response to the motion of the eyes of the viewer. Therefore, in the division of the screen into regions shown in FIG. 13, the first region A (105) is dynamically set very close to the center 108 of view field detected by detection of the view line of the viewer of the screen, and the second region B (106) is dynamically set around the first region A (105). The shapes of the first and second regions A (105) and B (106) are an example and do not limit the invention. Further, information of the size of each of the two regions A (105) and B (106) can be set from the outside of the display driver 220 or updated. With the arrangement, even in the case where the viewer does not pay attention to the center of the liquid crystal screen 102, high picture quality is realized in the region to which the viewer pays attention. On the other hand, the frame memory 224 can be saved in the region to which the viewer does not pay attention. Thus, the viewer can feel overall improvement in picture quality.

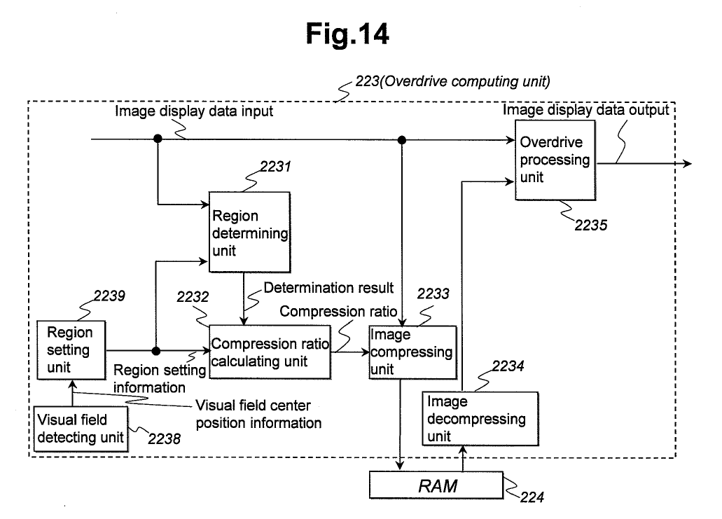

FIG. 14 is a diagram showing the configuration of the overdrive computing unit 223 of the display driver 220 of the fourth embodiment of the invention.

Like the overdrive computing unit 223 according to the first embodiment shown in FIG. 3, the overdrive computing unit 223 according to the fourth embodiment shown in FIG. 14 includes the region determining unit 2231, the compression ratio calculating unit 2232, the image compressing unit 2233, the image decompressing unit 2234, and the overdrive processing unit 2235. To the overdrive computing unit 223 in FIG. 11, a visual line detecting unit 2238 and a region setting unit 2239 are added. Further, in the overdrive computing unit 223 according to the fourth embodiment shown in FIG. 11, the visual line detecting unit 2238 generates position information of the center 108 of view field by executing detection of the visual line of the viewer. In response to the position information of the center 108 of view field generated by the visual line detecting unit 2238, the region setting unit 2239 generates border x coordinates x_{A}0, x_{A}1 and border y coordinates y_{A}0, y_{A}1 of the region A (105) and border x coordinates x_{B}0, x_{B}1 and border y coordinates y_{B}0, y_{B}1 of the region B (106) as region border x coordinates and region border y coordinates. The region setting information of the region border x coordinates and the region border y coordinates is supplied to the region determining unit 2231 and the compression ratio calculating unit 2232.

The operation of the overdrive computing unit 223 shown in FIG. 14 will be described below.

In the overdrive computing unit 223 shown in FIG. 14, the visual line detecting unit 2238 executes visual line detection, thereby generating position information of the center 108 of view field. In response to the position information of the center 108 of view field, the region setting unit 2239 generates region setting information of the regions A (105) and B (106) dynamically set in FIG. 13. The region setting information generated is supplied to the region determining unit 2231 and the compression ratio calculating unit 2232.

The image display data supplied from the CPU 210 to the display driver 220 of the fourth embodiment is supplied to the region determining unit 2231. Therefore, with reference to the region setting information of the region setting unit 2239, the region determining unit 2231 determines a region to which the image display data belongs from the region A (105) and the region B (106) dynamically set in FIG. 13 and the region C (107) statically set in FIG. 13. The determination result of the region determining unit 2231 is supplied to the compression ratio calculating unit 2232. In the case where the determination result of the region determining unit 2231 indicates any of the regions A (105), B (106), and C (107), according to the determination result, the compression ratio calculating unit 2232 sets any of the data compression ratios R_{A}, R_{B}, and R_{C} in the image compressing unit 2233. The image compressing unit 2233 compresses the image display data at the data compression ratio set by the compression ratio calculating unit 2232 and stores the compressed display data into the frame memory 224. The image display data stored in the frame memory 224 is read from the frame memory 224 at a timing when image display data of the same pixel of the following frame is supplied, and decompressed by the image decompressing unit 2234. On the other hand, the image display data of the same pixel in the following frame in the regions A (105), B (106), and C (107) is compared with the pixel data of the preceding frame decompressed by the image decompressing unit 2234 in the overdrive processing unit 2235, thereby generating image display data for overdrive.

According to the fourth embodiment described above with reference to FIGS. 13 and 14, high picture quality is realized in the regions A (105) and B (106) to which the viewer pays attention. On the other hand, the frame memory 224 can be saved in the region C (107) to which the viewer does not pay attention. Thus, the viewer can feel improvement in overall picture quality.

Although the present invention achieved by the inventors herein has been concretely descried on the basis of various embodiments, obviously, the invention is not limited to the embodiments but may be variously changed without departing from the gist.

For example, the present invention is not limited to a small liquid crystal display mounted on a cellular phone terminal and can be applied to a small liquid crystal display mounted on a PDA (Personal Digital Assistance) operated on battery, a portable game machine, a small notebook-sized personal computer, and the like.

Further, the invention can be applied not only to a small liquid crystal display but also an organic EL (ElectroLuminescence) display.

What is claimed is:

1. A display driver capable of driving a display device,
wherein the display driver can store, in a memory, image display data which has been compressed, and can generate a preceding frame by decompressing the data read from the memory,
wherein the display driver comprises a setting unit and an overdrive computing unit,
wherein the setting unit can divide a display screen of the display device into at least first and second regions,
wherein the overdrive computing unit can generate overdrive display data in response to a present-time frame to be supplied and the preceding frame, and
wherein the overdrive computing unit compresses image display data in the first region and image display data in the second region at a first data compression ratio and a second compression ratio which are different from each other, respectively, and can store the compressed data into the memory.

2. The display driver according to claim 1, wherein the overdrive computing unit generates the overdrive display data comprising an overshoot and an undershoot responding to the difference between the present time frame and the preceding frame.

3. The display driver according to claim 2,
wherein the overdrive computing unit comprises an image compressing unit and an image decompressing unit,
wherein the image compressing unit compresses the image display data stored in the memory, while the image decompressing unit decompresses the data read from the memory, and
wherein the image compressing unit compresses the image display data in the first region and the image display data in the second region at the first data compression ratio and the second data compression ratio which are different from each other, respectively, and stores the compressed data into the memory.

4. The display driver according to claim 3,
wherein the overdrive computing unit further comprises a region determining unit, and
wherein the region determining unit determines the first region or the second region to which the image display data belongs in response to a dot clock related to the image display data, a horizontal synchronization signal, and a perpendicular synchronization signal.

5. The display driver according to claim 4,
wherein the overdrive computing unit further comprises a compression ratio calculating unit, and
wherein the compression ratio calculating unit calculates the first data compression ratio and the second data compression ratio in response to region setting information related to division between the first and second regions of the display screen of the display device.

6. The display driver according to claim 1,
wherein the first and second regions which are divided in the display screen of the display device can be set in an almost center of the display screen and a periphery of the center, respectively, and
wherein the second data compression ratio for the second region of the periphery can be set to a value larger than the first data compression ratio for the first region of the almost center.

7. The display driver according to claim 1,
wherein the first and second regions divided on the display screen of the display device can be set to a region of center of visual field of the display screen detected by a line of sight of a viewer and a peripheral region, respectively, and
wherein the second data compression ratio for the second region as the peripheral region can be set to a value larger than that of the first data compression ratio for the first region as the region of the center of the visual field.

8. The display driver according to claim 6, wherein a liquid crystal display device can be driven as the display device.

9. The display driver according to claim 7, wherein a liquid crystal display device can be driven as the display device.

10. A driving method of a display driver capable of driving a display device,
wherein the display driver can store, in a memory, image display data which has been compressed, and can generate a preceding frame by decompressing the data read from the memory,
wherein the display driver comprises a setting unit and an overdrive computing unit,
wherein the setting unit can divide a display screen of the display device into at least first and second regions,
wherein the overdrive computing unit can generate overdrive display data in response to a present-time frame to be supplied and the preceding frame, and
wherein the overdrive computing unit compresses image display data in the first region and image display data in the second region at a first data compression ratio and a second compression ratio which are different from each other, respectively, and can store the compressed data into the memory.

11. The driving method of a display driver according to claim 10, wherein the overdrive computing unit generates the overdrive display data comprising an overshoot and an undershoot responding to the difference between the present-time frame and the preceding frame.

12. The driving method of a display driver according to claim 11,
wherein the overdrive computing unit comprises an image compressing unit and an image decompressing unit,
wherein the image compressing unit compresses the image display data stored in the memory, the image decompressing unit decompresses the data read from the memory, and
wherein the image compressing unit compresses the image display data in the first region and the image display data in the second region at the first data compression ratio and the second data compression ratio which are different from each other, respectively, and stores the compressed data into the memory.

13. The driving method of a display driver according to claim 12,
wherein the overdrive computing unit further comprises a region determining unit, and
wherein the region determining unit determines the first region or the second region to which the image display data belongs in response to a dot clock related to the image display data, a horizontal synchronization signal, and a perpendicular synchronization signal.

14. The driving method of a display driver according to claim 13,
wherein the overdrive computing unit further comprises a compression ratio calculating unit, and
wherein the compression ratio calculating unit calculates the first data compression ratio and the second data compression ratio in response to region setting information related to division between the first and second regions of the display screen of the display device.

15. The driving method of a display driver according to claim 10,
wherein the first and second regions which are divided in the display screen of the display device can be set in an almost center of the display screen and a periphery of the center, respectively, and
wherein the second data compression ratio for the second region of the periphery can be set to a value larger than the first data compression ratio for the first region of the almost center.

16. The driving method of a display driver according to claim 10,
wherein the first and second regions divided on the display screen of the display device can be set to a region of center of visual field of the display screen detected by a line of sight of a viewer and a peripheral region, respectively, and
wherein the second data compression ratio for the second region as the peripheral region can be set to a value larger than that of the first data compression ratio for the first region as the region of the center of the visual field.

17. The driving method of a display driver according to claim 15, wherein a liquid crystal display device can be driven as the display device.

18. The driving method of a display driver according to claim 16, wherein a liquid crystal display device can be driven as the display device.
